(19) United States
(12) Patent Application Publication
(10) Pub. No.: US 2020/0067183 A1
(43) Pub. Date: Feb. 27, 2020

(54) BROADBAND DUAL-POLARIZED MICROSTRIP ANTENNA USING A FR4-BASED ELEMENT HAVING LOW CROSS-POLARIZATION AND FLAT BROADSIDE GAIN AND METHOD THEREFOR

(71) Applicant: BENCHMARK ELECTRONICS, INC., Tempe, AZ (US)

(72) Inventor: ARKAJYOTI CHANG, TEMPE, AZ (US)

(73) Assignee: BENCHMARK ELECTRONICS, INC., TEMPE, AZ (US)

(21) Appl. No.: 16/576,593

(22) Filed: Sep. 19, 2019

Related U.S. Application Data
(60) Provisional application No. 62/765,329, filed on Aug. 22, 2018.

(51) Int. Cl. H01Q 1/38; H01Q 9/04; H01Q 1/52

(52) U.S. Cl. CPC H01Q 1/38; H01Q 1/523; H01Q 9/0457

(57) ABSTRACT

An antenna assembly has a first antenna layer. A second antenna layer is spaced apart from the first antenna layer. A feed layer excites the first antenna layer and the second antenna layer. The feed layer is spaced apart from the second antenna layer. A reflective layer is spaced apart from the feed layer.

### TECHNICAL FIELD

The present application in general relates to antennas, and more specifically, a broadband dual-polarized microstrip antenna which uses an FR-4 substrate which has low cross-polarization and flat broadside gain.

### BACKGROUND

For broadening the bandwidth of a microstrip antenna to over 50%, an aperture stacked patch approach may be taken. This approach may be effective for a dual polarization, since there is an inherent polarization purity associated.

The front-to-back ratio (FBR) in aperture coupled antennas is generally low. However, to achieve a flat broadside gain, a good FBR ratio for the whole bandwidth of the antenna should be maintained. This can be obtained by using a microstrip patch antenna, or a cross as a reflector in the back of an aperture-coupled stacked patch configuration. To minimize the coupling between the orthogonal polarizations in a dual polarized antenna, and in turn to maintain low cross polarization, a balanced feed can be used, which may involve a feed line branched into two traces to excite the antenna, and a cross-slot to couple both the feed lines for both polarizations to the antenna.

Classically, to achieve considerable bandwidth, its recommended to use a low permittivity, low loss substrate of high thickness. However, these types of substrates are more expensive than off-the-shelf thin FR4 material. Presently, it is difficult to achieve a good return loss and flat gain for a broadband and limited size antenna element using off-the-shelf thin FR4 material as the substrate for the antenna.

Therefore, it would be desirable to provide a system and method that overcomes the above. The system and method would provide a broadband dual-polarized antenna solution based on commercially available low-cost substrate.

### SUMMARY

In accordance with one embodiment, an antenna assembly is disclosed. The antenna assembly has a first antenna layer. A second antenna layer spaced apart from the first antenna layer. A feed layer is used to excite the first antenna layer and the second antenna layer. The feed layer is spaced apart from the second antenna layer. A reflective layer is spaced apart from the feed layer.

In accordance with one embodiment, an antenna assembly is disclosed. The antenna assembly has a first antenna layer. The first antenna layer has a first substrate. A first antenna element is formed on a bottom surface of the first substrate. A second antenna layer is spaced apart from the first antenna layer. The second antenna layer has a second substrate. A second antenna element is formed on a top surface of the second substrate. A first air spacer is positioned between the first antenna layer and the second antenna layer. The first antenna element and the second antenna element are positioned within the first air spacer. A feed layer is used to excite the first antenna layer and the second antenna layer. The feed layer is spaced apart from the second antenna layer. The feed layer has a third substrate. A first feed line is formed on the third substrate. A fourth substrate is provided. A second feed line is formed on the fourth substrate. A ground plane isolates the first feed line from the second feed line. A reflective layer is spaced apart from the feed layer. The reflective layer has a fifth substrate. A Jerusalem cross type reflector is formed on the fifth substrate. A second air spacer positioned between a second feed line and the a Jerusalem cross type reflector.

### BRIEF DESCRIPTION OF THE DRAWINGS

The present application is further detailed with respect to the following drawings. These figures are not intended to limit the scope of the present application but rather illustrate certain attributes thereof.

FIG. 1 is a cross-sectional view of an exemplary antenna according to one aspect of the present application;

FIG. 2 is an exploded view depicting different layers of the exemplary antenna of FIG. 1 according to one aspect of the present application;

FIG. 3 shows a graph depicting an exemplary return loss for X polarized port of the exemplary antenna of FIG. 1 according to one aspect of the present application;

FIG. 4 shows a graph depicting an exemplary return loss for Y polarized port of the exemplary antenna of FIG. 1 according to one aspect of the present application;

FIG. 5 shows a graph depicting the isolation between the two orthogonally polarized feeds of the exemplary antenna of FIG. 1 according to one aspect of the present application; and

FIG. 6 shows a graph representing the broadside realized gain of the exemplary antenna of FIG. 1 according to one aspect of the present application.

### DESCRIPTION OF THE APPLICATION

The description set forth below in connection with the appended drawings is intended as a description of presently preferred embodiments of the disclosure and is not intended to represent the only forms in which the present disclosure may be constructed and/or utilized. The description sets forth the functions and the sequence of steps for constructing and operating the disclosure in connection with the illustrated embodiments. It is to be understood, however, that the same or equivalent functions and sequences may be accomplished by different embodiments that are also intended to be encompassed within the spirit and scope of this disclosure.

Embodiments of the exemplary method and system may allow an antenna element to be built using a Commercial Off-The-Shelf (COTS) FR4 based substrate. To achieve bandwidth, a stacked patch may be used. An aperture-coupled configuration may be used for broadbanding. The antenna may use a special reflector to achieve a good front to back ratio required to maintain a flat gain.

For a broadband antenna, a thick substrate with low dielectric constant is generally preferred since it may lead to stronger fringing fields, which ultimately increases the radiated power. But the problem with thicker dielectric material with a low dielectric constant is that the substrate cost is generally higher. The thickness of the substrate can be reduced by using an air spacer. This may also help to lower the effective dielectric constant for a high dielectric constant material. But as the difference in dielectric constant increases, there may be more reflection at the interface of the dielectric substrate and the air spacer, which may make it challenging to keep the gain above prescribed levels in the required bandwidth. Although the air spacer height can be increased to reduce the effective dielectric constant, it cannot be increased over a certain limit since the coupling between the feed line and the antenna will become considerably poor.

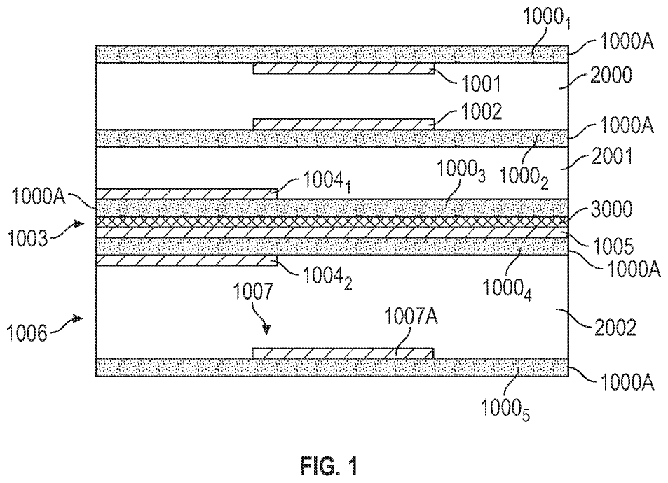

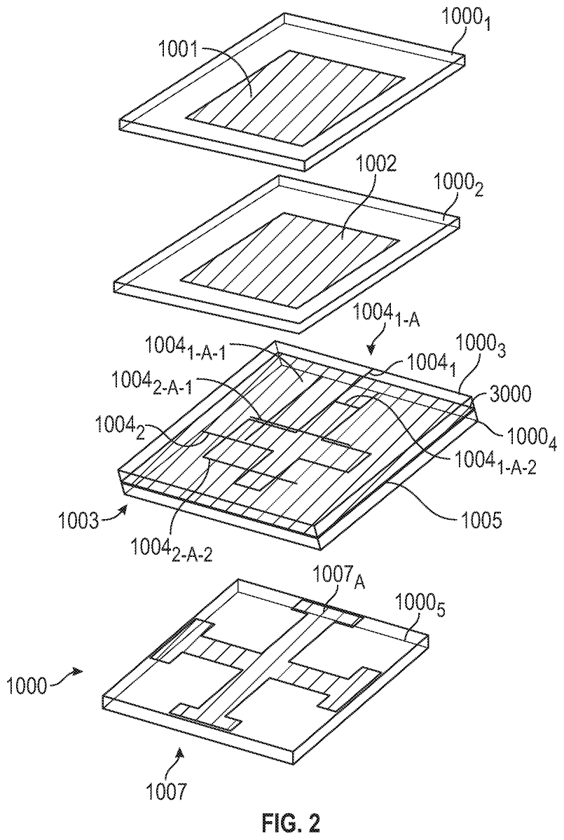

Referring to FIGS. 1-2, one embodiment of an antenna assembly may be seen. The antenna assembly is a multi-layer antenna assembly. The antenna assembly may be formed of a first antenna 1001. The first antenna 1001 may formed on a bottom surface of a first substrate 1000₁. In accordance with one embodiment, the first antenna 1001 may be an a driven electromagnetically coupled patch-type antenna.

The first substrate 1000₁ may be a commercial off the shelf FR4 substrate 1000A. FR4 substrate 1000A may be formed of a glass-reinforced epoxy laminate material. The FR4 substrate 1000A may be formed of a composite material composed of woven fiberglass cloth with an epoxy resin binder. In accordance with one embodiment, the FR4 substrate 1000A may be approximately 21 mils in height.

A second antenna 1002 may be formed on a top surface of a second substrate 1000₂. In accordance with one embodiment, the second antenna 1002 may be a parasitic patch-type antenna. The second substrate 1000₂ may be a commercial off the shelf FR4 substrate 1000A. In accordance with one embodiment, the FR4 substrate 1000A may be approximately 21 mils in height.

The first antenna 1001 may be slightly smaller in size than the second antenna 1002. By having the first antenna 1001 slightly smaller in size than the second antenna 1002, one may be able to achieve two slightly different fundamental frequencies in them, as principle of broad banding using stacked-patches dictate.

The antenna 1001 on the bottom surface of the first substrate 1000₁, may be separated from the second antenna 1002 formed on the top surface of the second substrate 1000₂ by an air-spacer 2000. The first antenna 1001 and the second antenna 1002 may both be located within the air-spacer 2000. As may be seen in FIG. 1, first antenna 1001 and the second antenna 1002 may both be planer elements and parallel to one another.

The antenna assembly may have a feed layer 1003. The second antenna 1002 formed on a top surface of a second substrate 1000₂ may be separated from the feed layer 1003 of the antenna assembly by an air spacer 2001. The feed layer 1003 of the antenna assembly may have feedlines 1004₁ and 1004₂. The feed line 1004₁ may be formed on a top surface of a third substrate 1000₃. The feed line 1004₂ may be formed on a top surface of a fourth substrate 1000₄. The feed line 1004₁ may be formed on a top surface of a third substrate 1000₃ may be positioned within the air spacer 2001. The feedlines 1004₁ and 1004₂ may be used as X polarized) (Φ=0°) and Y polarized) (Φ=90°) balanced feed lines respectively. The feedlines 1004₁ and 1004₂ may be isolated by a solid ground plane 1005 with a cross-slot 1005A in a 4-layer board, which is comprised of the third substrate 1000₃ and fourth substrate 1000₄ coupled together.

In accordance with one embodiment, the feed line 1004₁ may be a single feed line 1004_{1_A} that branch off into two feed lines 1004_{1_A_1} and 1004_{1_A_2} that symmetrically distanced from the single feed line 1004_{1_A}. Similarly, the feed line 1004₂ may be a single feed line 1004₂ that branch off into two feed lines 1004_{2_A_1} and 1004_{2_A_1} that symmetrically distanced from the single feed line 1004_{2_A}. For example, the feed lines 1004₁ and 1004₂ may both be a 50 Ohm feed line that branches into two lines of 100 Ohms and are symmetrically distanced from the central 50 Ohm line.

In accordance with one embodiment, the third substrate 1000₃ and fourth substrate 1000₄ may be coupled together with an adhesive 3000. The cross-slot 1005 may give symmetry in the coupling of two feedlines 1004₁ and 1004₂ for each polarization, and makes the feed lines 1004₁ and 1004₂ balanced. In the above example, the cross-slot 1005 may give symmetry in the coupling of two 100 Ohms feedline branches of the feed lines 1004₁ and 1004₂. The two 100 Ohms feedline branches of the feed lines 1004₁ and 1004₂. May be symmetrically placed in different layers of the ground plane with the cross-slot 1005.

In accordance with one embodiment, the third substrate 1000₃ and the fourth substrate 1000₄ may both be a commercial off the shelf FR4 substrate 1000A. The FR4 substrate 1000A may be approximately 21 mils in height. In this embodiment, the third substrate 1000₃ and the fourth substrate 1000₄ may be coupled together with 2.8 mils thick adhesive 3000.

The antenna assembly may have a reflector layer 1006. The reflector layer 1006 may have a reflector 1007 formed on a top surface of a fifth substrate 1000₅. The fifth substrate 1000₅ may be a commercial off the shelf FR4 substrate 1000A. In accordance with one embodiment, the FR4 substrate 1000A may be approximately 21 mils in height. The reflector layer 1006 may be separated from the feed line 1004₂ by air spacer 2002. The reflector 1007 and the feed line 1004₂ may be positioned within the air spacer 2002.

In accordance with one embodiment, the reflector 1007 may be a Jerusalem cross-shaped reflector 1007A as may be seen in FIG. 2. The Jerusalem cross-shaped reflector 1007A may be designed and introduced in the bottom-most layer to increase the FBR ratio. The Jerusalem cross-shaped reflector 1007A compensates the reduction in the FBR caused by the higher reflective losses at the air-dielectric interface. In the antenna assembly, the reflector 1007 should be broadband to support the prescribed gain over the entire band. At a frequency like UHF, keeping a reasonable size of the ground plane of the antenna element for appreciable broadside gain makes the reflector design more critical, since reduction of ground plane size increases the back radiation. The Jerusalem cross-shaped reflector 1007A appears to meet the above requirements, since broad bandwidth, and a relatively stable frequency characteristic for widely varying angle of incidence can be obtained using Jerusalem cross-shaped reflector 1007A.

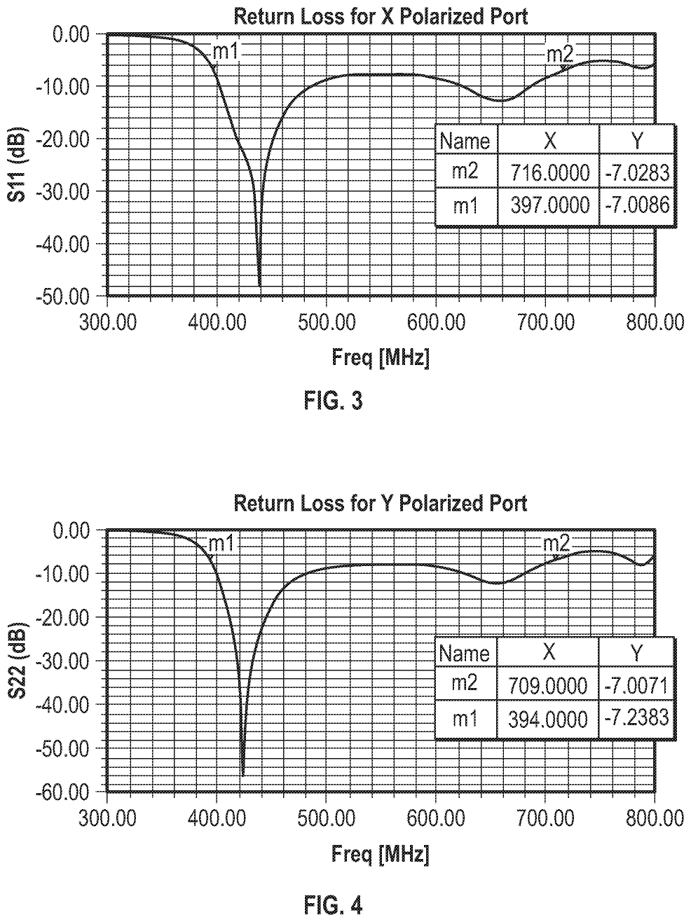

A return loss plot for the X-polarized feed line 1004₁ may be seen in FIG. 3. It can be seen that the antenna is impedance matched such that 7 dB return loss bandwidth is 59.8%, from 397 MHz to 712 MHz.

The return loss plot for Y-polarized feed line 1004₂, may be illustrated in FIG. 4. The return loss plot for Y-polarized feed line 1004₂ may shows that the 7 dB return loss bandwidth is 59.6%, from 394 MHz to 709 MHz.

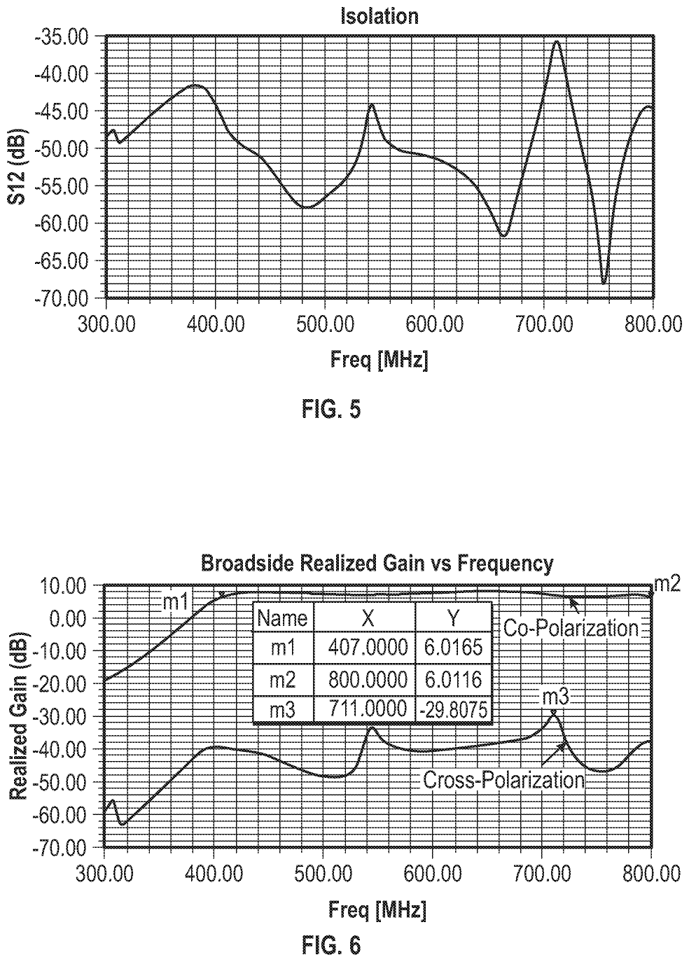

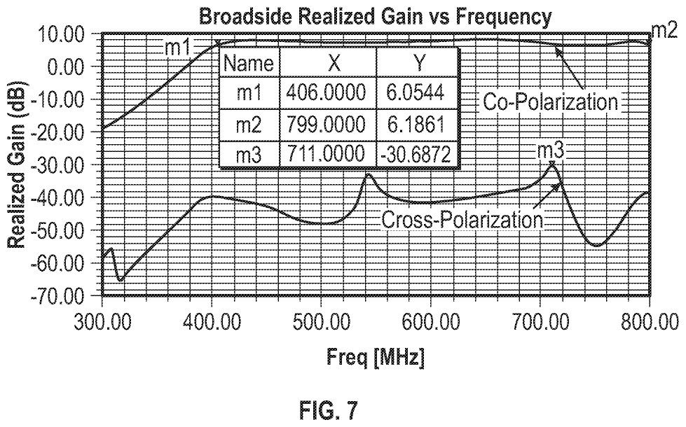

The isolation between the two orthogonal feedlines 1004₁ and 1004₂ may be seen in FIG. 5 to be lower than −35 dB for the whole band. The broadside gain may be defined as the gain seen from Zenith, i.e. θ=0°. This may be shown in FIG. 6 for the case when X-polarized feed line 1004₁ only is excited. FIG. 7 may show the case when only Y-polarized feed line 1004₂ is excited. In both FIG. 6 and FIG. 7, the co-polarized and cross polarized cases are marked. Its seen in FIG. 6 that the 6 dB gain bandwidth for X-polarized case is 68.87% from 407 MHz to 800 MHz. It appears in FIG. 7 that the 6 dB bandwidth for Y-polarized case is 69% from 406 MHz to 799 MHz.

The foregoing description is illustrative of particular embodiments of the application, but is not meant to be a limitation upon the practice thereof. The following claims, including all equivalents thereof, are intended to define the scope of the application.

What is claimed is:

1. An antenna assembly comprising:
a first antenna layer;
a second antenna layer spaced apart from the first antenna layer;
a feed layer exciting the first antenna layer and the second antenna layer, the feed layer spaced apart from the second antenna layer; and
a reflective layer spaced apart from the feed layer.

2. The antenna assembly of claim 1, wherein the first antenna layer comprises:
a first substrate; and
a first antenna element formed on a bottom surface of the first substrate.

3. The antenna assembly of claim 2, wherein the first substrate is an FR4 type substrate.

4. The antenna assembly of claim 2, wherein the second antenna layer comprises:
a second substrate; and
a second antenna element formed on a top surface of the first substrate.

5. The antenna assembly of claim 4, wherein the second substrate is an FR4 type substrate.

6. The antenna assembly of claim 4, comprising a first air spacer positioned between the first antenna layer and the second antenna layer, the first antenna element and the second antenna element positioned within the first air spacer.

7. The antenna assembly of claim 4, wherein the first antenna element and the second antenna element are planer and parallel to each other.

8. The antenna assembly of claim 2, wherein the first antenna element is a driven electromagnetically coupled patch-type antenna.

9. The antenna assembly of claim 4, where the second antenna element is a parasitic patch-type antenna.

10. The antenna assembly of claim 4, wherein the first antenna element is larger than the second antenna element.

11. The antenna assembly of claim 1, wherein the feed layer comprises:
a first feed line;
a second feed line; and
a ground plane isolating the first feed line from the second feed line.

12. The antenna assembly of claim 11, wherein the ground plane is a solid ground plane with a cross-slot.

13. The antenna assembly of claim 11, wherein the first feed line and the second feed line each comprises a main feed line that branches into two branch feed lines, the branch feed lines symmetrically distanced from the main feed line.

14. The antenna assembly of claim 11, comprising a second air spacer formed between the first feedline and the second antenna layer.

15. The antenna assembly of claim 1, wherein the feed layer comprises:
a first feed layer substrate;
a first feed line formed on the first feed layer substrate;
a second feed line substrate;
a second feed line formed on the second feed layer substrate; and
a ground plane isolating the first feed line from the second feed line.

16. The antenna assembly of claim 15, wherein the first feed layer substrate and the second feed layer substrate are both FR4 type substrates.

17. The antenna assembly of claim 1, wherein the reflective layer comprises a Jerusalem cross type reflector.

18. The antenna assembly of claim 1, wherein the reflective layer comprises:
a third substrate; and
a Jerusalem cross type reflector formed on the third substrate, wherein the third substrate is an FR4 type substrate.

19. The antenna assembly of claim 1, comprising a third air spacer formed between the reflector layer and the feed layer.

20. An antenna assembly comprising:
a first antenna layer wherein the first antenna layer comprises:
a first substrate; and
a first antenna element formed on a bottom surface of the first substrate;
a second antenna layer spaced apart from the first antenna layer, wherein the second antenna layer comprises:
a second substrate; and
a second antenna element formed on a top surface of the second substrate;
a first air spacer positioned between the first antenna layer and the second antenna layer, the first antenna element and the second antenna element positioned within the first air spacer;
a feed layer exciting the first antenna layer and the second antenna layer, the feed layer spaced apart from the second antenna layer, wherein the feed layer comprises:
a third substrate;
a first feed line formed on the third substrate;
a fourth substrate;
a second feed line formed on the fourth substrate; and
a ground plane isolating the first feed line from the second feed line;
a second air spacer formed between the first feedline and the second antenna layer;
a reflective layer spaced apart from the feed layer, wherein the reflective layer comprises:
a fifth substrate; and
a Jerusalem cross type reflector formed on the fifth substrate; and
a third air spacer positioned between a second feed line and the Jerusalem cross type reflector.

21. The antenna assembly of claim 20, wherein the first substrate, second substrate, third substrate, fourth substrate and fifth substrate are all FR4 type substrates.

22. The antenna assembly of claim 20, wherein the first antenna element and the second antenna element are planer and parallel to each other.

23. The antenna assembly of claim 20, wherein the first antenna element is larger than the second antenna element.

24. The antenna assembly of claim 20, wherein the ground plane is a solid ground plane with a cross-slot.

25. The antenna assembly of claim 20, wherein the first feed line and the second feed line each comprises a main feed line that branches into two branch feed lines, the branch feed lines symmetrically distanced from the main feed line.
